(19) United States
(12) Patent Application Publication
(10) Pub. No.: US 2008/0202442 A1
(43) Pub. Date: Aug. 28, 2008

(54) SYSTEM FOR COLLECTING SPAT

(76) Inventor: Norman L. Hodgkins, Hancock, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 11/679,588

(22) Filed: Feb. 27, 2007

(51) Int. Cl. A01K 61/00

(52) U.S. Cl. 119/237

(57) ABSTRACT

An improved spat collection system and method of use thereof, said system comprising a plurality of spat collection panels suspended from a floatation device placed in a marine environment, said panels attached to said floatation device by a suspension mechanism, and a predator protection device adapted to surround the panels to minimize predation of spat collected thereon; said method comprising the steps of placing said spat collection system in a suitable marine environment, allowing said spat collection system to remain in the marine environment for an appropriate length of time, then withdrawing one or more spat collection panels from the marine environment and scraping accumulated spat from said panel into a container before replacing said panel in the marine environment.

### BACKGROUND OF THE INVENTION

1. Technical Field

The present invention relates generally to the field of aquaculture and specifically to the field of harvesting juvenile mollusks (“spat”) for use in raising mollusks for commercial purposes, said invention comprising a system for collecting spat from marine environments and a method of spat collection using same.

2. Description of Prior Art

The blue mussel, Mytilus edulis, is a common, rocky intertidal and subtidal bivalve mollusk, which is harvested extensively in the Northeastern United States and Atlantic provinces of Canada. Historically mussels have been harvested from natural beds and bottom culture leases seeded with juvenile mussels, known as “spat”. Spat is initially free floating, but attaches to surfaces with which it comes into contact and upon which it grows into mature mussels. The mussel aquaculture industry typically uses wild caught spat to seed culture sites. A growing market demand for blue mussels in the U.S. has created a corresponding demand for spat and a need for an efficient means for the harvesting of spat.

Spat may be collected in mesh bags submerged in marine environments where wild spat may be found. Spat is carried by currents through the mesh and, largely fortuitously, an amount of spat attaches to the mesh. As the spat grows in size it exceeds the mesh size and remains trapped therein for harvesting. However, this method is inefficient because the mesh bags do not provide ideal attachment points for spat. Most spat passing by or through the mesh bags continues on its way without ever attaching to the mesh. Even the spat that contacts the mesh often fails to attach thereto, due to the minimal surface area presented by the strands comprising the mesh. Alternatively, spat may be collected using submerged lengths of rope. While rope presents a greater surface area onto which spat may attach as compared to mesh bags, it also fails to collect the vast majority of spat passing by. Rope spat collectors also are typically placed in deep water (to allow for increased lengths of rope), which may cause interference with other marine uses, notably shipping and recreation, and require special equipment to dislodge the spat from the rope. Spat attached to rope collectors is vulnerable to predation from both marine predators and fowl, such as sea ducks.

There is therefore a need for a spat collection system which efficiently collects spat, can be used in shallow waters, minimizes losses due to predation, and is easy to manufacture, use, and maintain.

It is therefore an objective of this invention to provide an improved spat collection system which is suitable for use in shallow waters.

It is a further objective of this invention to provide an improved spat collection system which minimizes losses due to predation.

It is yet a further objective of this invention to provide an improved spat collection system which can be easily manufactured, assembled, and disassembled for transport and storage.

It is yet a further objective of this invention to provide an improved spat collection system which can be easily used and maintained.

It is yet a further objective of this invention to provide an improved spat collection system which can also be used to cultivate mollusks.

It is yet a further objective of this invention to provide a method of collecting spat which uses an improved spat collection system.

It is yet a further objective of this invention to provide a method of cultivating mollusks which uses an improved spat collection system.

Other objectives of this invention will be evident from the following disclosure.

### SUMMARY

The present invention is directed to an improved spat collection system. The primary components of the system are a plurality of spat collection panels, a floatation device suitably adapted to float in a marine environment and suitably adapted to support the spat collection panels, a suspension mechanism suitably adapted to removably attach the spat collection panels to the floatation device, and a predator protection device. The panels are planar, rigid, and smooth, and in the preferred embodiment each comprises pegs depending perpendicularly from each surface to increase the attachment surfaces for the spat. Wild spat flows by and into the panels, whereby it attaches thereto and grows. The floatation device supports the panels under water above the sea floor in a generally horizontal arrangement, thereby permitting placement of the system in relatively shallow waters. The predator protection device prevents large predators, such as sea ducks, from eating the spat attached to the panels, while still allowing the free flow of water, spat, and nutrients to the panels. The separation of the panels from the sea floor also lessens predation from bottom-dwelling predators.

The method of collecting spat uses the disclosed spat collection system. It involves placing the system in an appropriate marine environment, leaving the system in the marine environment for an appropriate length of time, then withdrawing the panels and scraping off the accumulated spat into a container. The panels may then be replaced and the steps repeated, as desired.

The disclosed spat collection system may also be used to cultivate mollusks, such as blue mussels. The spat that is collected by the system will eventually grow into mature mollusks if it is not removed from the panels. Simply leaving the system in the marine environment for an extended length of time allows the cultivation of mature mollusks. Periodically thinning the accumulated mollusks improves the cultivation of mature mollusks.

The components of the system of the present invention can be easily and inexpensively manufactured. For example, scrap fiberglass may be used for the panels, pressure treated wooden beams attached to Styrofoam™ blocks can be used for the floatation device, and wire mesh of the type used for lobster traps may be used for the predator protection device. The suspension mechanism can be readily available stainless steel rods. Those skilled in the art will be able to ascertain many other manufacturing efficiencies inherent in the design of the present invention.

Other features and advantages of the invention are described below.

### DESCRIPTION OF THE DRAWINGS

FIG. 1 is a perspective view of the system.

FIG. 2 is a plan view of a spat collection panel, having the optional engagement feet and handle, and having wild spat attached thereto.

FIG. 3A is a perspective view of a spat collection panel with removable pegs.

FIG. 3B is a cross sectional view of a spat collection panel with through pegs.

FIG. 3C is a cross sectional view of a spat collection panel with fixed pegs.

FIG. 4 is a perspective view of one step in the spat collection method, demonstrating the scraping of spat from the spat collection panel into a container after removal of through pegs.

### DETAILED DESCRIPTION OF THE INVENTION

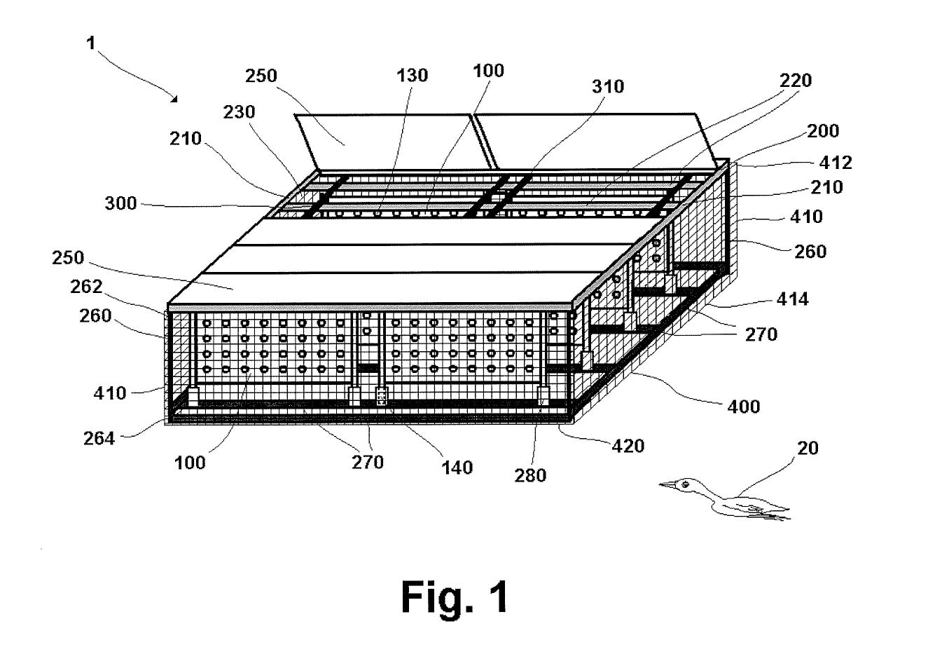

The present invention comprises an improved spat collection system 1. The system 1 comprises a plurality of spat collection panels 100, a floatation device 200, and a suspension mechanism 300. See FIG. 1. In the preferred embodiment the system 1 also comprises a predator protection device 400. The system 1 is designed to be placed in a marine environment, typically in shallow coastal waters where spat 10 is most prevalent. The floatation device 200 maintains the top of the system 1 at the water's surface, while supporting the spat collection panels 100 below by use of the suspension mechanism 300. In this configuration the spat collection panels 100 remain substantially submerged during use. The predator protection device 400, when employed, provides a barrier to larger predators 20 by surrounding and enclosing the spat collection panels 100, yet still permits the free flow of water, spat 10, and nutrients to the system 1. The system 1 is intended to float above the ocean floor, thereby preventing easy access thereto by bottom dwelling predators 20.

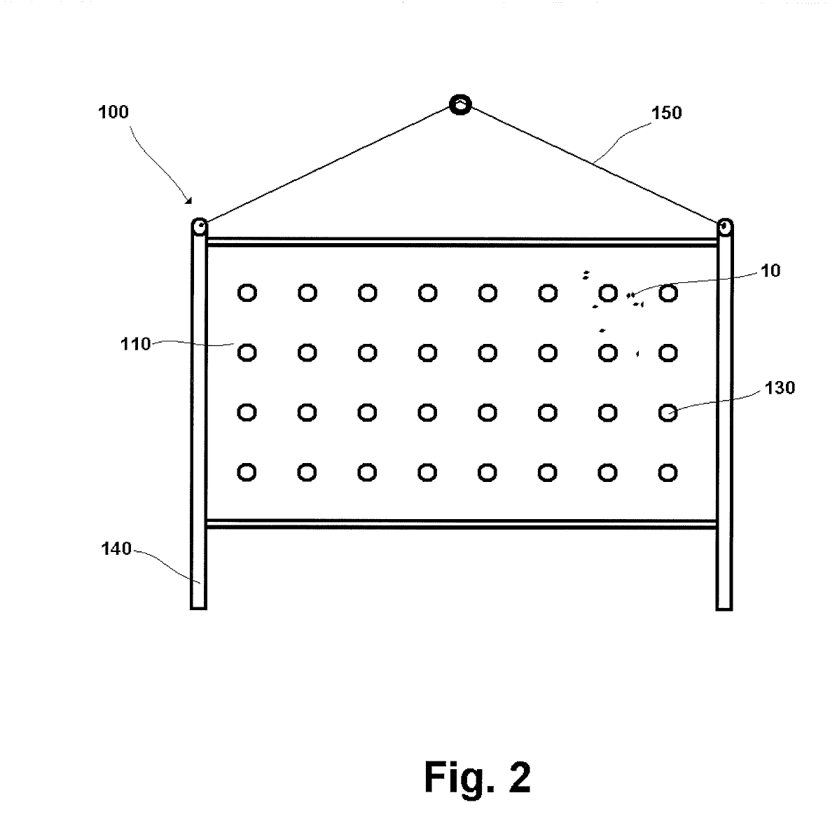

Each of the spat collection panels 100 is substantially planar and substantially rigid. See FIG. 2. While the spat collection panels 100 may be constructed of any suitable materials exhibiting these qualities, they are ideally constructed of at least one material providing them with neutral buoyancy. The spat collection panels 100 may be of any shape and size, though the preferred shape and size for efficient handling is rectangular with a length approximately twice the width, with overall length preferably between four and ten feet. In the most preferred embodiment the spat collection panels 100 are eight feet by four feet, and all of the spat collection panels 100 are substantially the same size and shape. Other shapes and sizes are also contemplated by the present invention, as well as different shapes and sizes among the spat collection panels 100. In the preferred embodiment the spat collection panels 100 are oriented within the system 1 substantially parallel to or coplanar with each other. See FIG. 1.

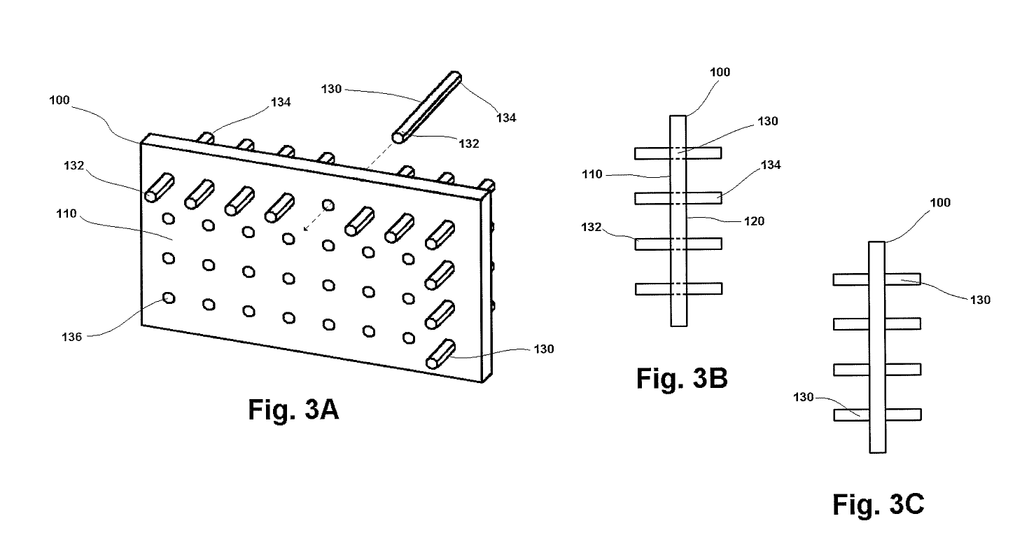

Each spat collection panel 100 has a first surface 110 and a second surface 120. See FIG. 3B. In one embodiment the surfaces 110,120 of the spat collection panels 100 are smooth. In the preferred embodiment, the surfaces 110,120 are slightly textured, thereby providing better attachment points for the wild spat 10 that comes in contact therewith.

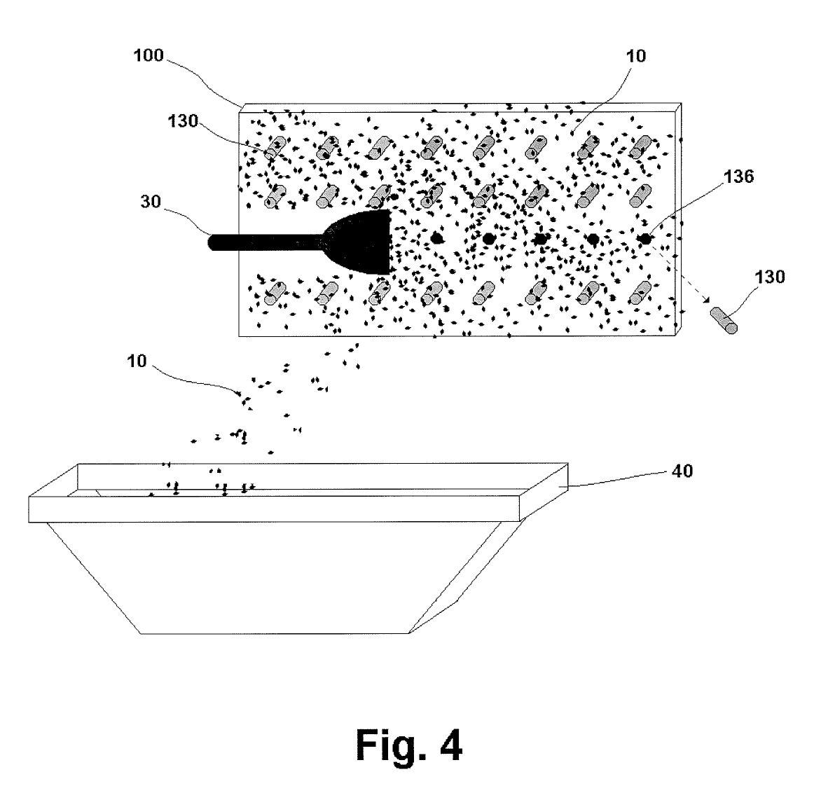

The configuration of the spat collection panels 100 and their orientation within the system 1 allows water to flow around them relatively unimpeded. This allows the maximum amount of spat 10 to come into close proximity to the spat collection panels 100. However, to increase the surfaces upon which spat 10 may attach, one embodiment of the spat collection panels 100 further comprises a plurality of pegs 130. See FIG. 2. The pegs 130 may be of any shape and size, though in the preferred embodiment they are substantially cylindrical, and between four and six inches in length. The pegs 130 are attached to and depend substantially perpendicularly from both the first and second surfaces 110,120 of each spat collection panel 100. In the preferred embodiment the spat collection panels 100 have peg holes 136 formed into their surfaces 110,120, with the peg holes 136 suitably adapted to accommodate the pegs 130. See FIG. 3A. The pegs 130 may be fixedly attached to each surface 110,120 of the spat collection panel 100, see FIG. 3C, or the pegs 130 may be removably attached to the surfaces 110,120, see FIG. 4. Removable pegs 130 facilitate the harvesting of the spat 10. See FIG. 4.

In an alternative embodiment, the peg holes 136 pass completely through the spat collection panels 100, and the pegs 130 are placed into and through the peg holes 136 such that the first end 132 of the peg 130 depends from the first surface 110 of the spat collection panel 100 and the second end 134 of the peg 130 depends from the second surface 120 of the spat collection panel 100. See FIG. 3B. In this embodiment the pegs 130 are preferably between eight and fifteen inches in length. The pegs 130 may be frictionally secured to the spat collection panels 100. In this embodiment the pegs 130 may be fixedly attached to the spat collection panel 100, or the pegs 130 may be removably attached to the spat collection panel 100. See FIG. 3A.

The spat collection panels 100 may further comprise a handle 150 to facilitate the lifting of the spat collection panel 100 from the system 1. In one embodiment the handle 150 is a wire cable or chain attached at either end to the upper corners of the spat collection panel 100. See FIG. 2. A free ring may be placed onto the handle 150, such that a hooking device from a winch may be inserted into the ring, allowing the spat collection panel 100 to self-level as it is lifted from the system 1. Other configurations for the handle 150 are also contemplated.

The floatation device 200, which supports the spat collection panels 100, is adapted to float substantially at the surface of the marine environment while keeping the spat collection panels 100 substantially below the surface but above the sea floor. In one embodiment the floatation device 200 comprises a substantially open, rigid frame 210, a plurality of horizontal support members 220 within the frame 210, and floatation material. The floatation material may be attached to the frame 210 or integrated therewith, for example within a hollow frame 210, or it may be comprised of the frame 210 itself, for example where the frame 210 is constructed of wood. The frame 210 is oriented substantially horizontally during use. The horizontal support members 220 are located within the frame 210, acting as cross members, and are oriented substantially parallel to each other. One or more of the horizontal support members 220 is suitably adapted to support the suspension mechanism 300, which in turn supports the spat collection panels 100. The horizontal support members 220 are arranged such that gaps 230 are formed between adjacent horizontal support members 220 as well as between the frame 210 and adjacent horizontal support members 220. These gaps 230 are wide enough to permit a spat collection panel 100 to pass through for removal from the system 1. See FIG. 1.

In one embodiment the floatation device 200 further comprises a covering mechanism 250 which is placed over at least a portion of the horizontal support members 220. The covering mechanism 250 serves two purposes: it is used primarily to provide or deny access to the spat collection panels 100 through the gaps 230, and it also serves as a platform for a user to stand upon. In the preferred embodiment the covering mechanism 250 covers all of the horizontal support members 220 as well as the frame 210. The covering mechanism 250 may be hinged so that it can be more easily positioned to either provide or deny access to the spat collection panels 100. The covering mechanism 250 may also comprise multiple hinged doors. See FIG. 1.

In another embodiment the floatation device 200 further comprises a plurality of vertical support members 260 and a floor component 270 attached to the lower ends 264 of the vertical support members 260. Each vertical support member 260 is attached at its upper end 262 to the frame 210, with each vertical support member 260 depending downward from the frame 210 and oriented substantially vertically. Each vertical support member 260 is substantially the same length as each other vertical support member 260. Preferably there are four vertical support members 260. See FIG. 1. The floor component 270 is oriented substantially horizontally; in the preferred embodiment the floor component 270 comprises cross members which are oriented substantially parallel to each other and parallel to the horizontal support members 220.

In one embodiment the spat collection panels 100 are adapted to engage with the cross members of the floor component 270. This causes each spat collection panel 100 to remain in a relatively fixed orientation relative to each other spat collection panel 100. In the preferred embodiment each of the spat collection panels 100 further comprises a pair of engagement feet 140 to engage with the floor component 270. In the most preferred embodiment the cross members of the floor component 270 comprise receivers 280 suitably adapted to engage with the engagement feet 140 of the spat collection panels 100. See FIG. 1. In this embodiment the receivers 280 may be open topped cylinders fixedly attached to the cross members of the floor component; the engagement feet 140 of the spat collection panels 100 insert into the receivers 280, minimizing excessive side to side or back and forth movement, but allowing some play between the spat collection panels 100 and the floor component 270. This achieves the goal of keeping the spat collection panels 100 in a substantially fixed orientation to each other while also providing easy insertion and removal of the spat collection panels 100 from the system 1.

The suspension mechanism 300 is suitably adapted to removably attach the spat collection panels 100 to the floatation device 200. In one embodiment the suspension mechanism 300 is comprised of a plurality of horizontally oriented rods 310. Each of the rods 310 is adapted to pass through a spat collection panel 100 and to engage with at least one horizontal support member 220. In the preferred embodiment the rods 310 are cylindrical and sufficiently long to span the gaps 230 between adjacent horizontal support members 220. Each spat collection panel 100 comprises a pair of apertures in the upper corners through which the rods 310 pass, and the horizontal support members 200 comprise semi-cylindrical notches running across the widths of the upper surfaces of the horizontal support members 220. The rods 310 are passed through the apertures of the spat collection panels 100 and their ends are placed into the notches of the horizontal support members 220. The covering mechanism 250 then is placed over the horizontal support members 220, holding the rods 310 in place. This configuration allows for easy insertion and removal of the spat collection panels 100 into the system 1. Other embodiments of the suspension mechanism 300 are also contemplated. For example, the suspension mechanism 300 may be a rope, flexible wire cable, or a chain attaching the spat collection panels 100 to the horizontal support members 220.

The optional predator protection device 400 is intended to minimize losses of spat 10 from predation. The predator protection device 400 is attached to and positioned below the floatation device 200 such that the predator protection device 400 extends around and below the spat collection panels 100 when the system 1 is in use, thereby enclosing, in conjunction with the floatation device 200, the spat collection panels 100. The predator protection device 400 must be substantially porous so that water, spat 10, and nutrients may pass through it. In one embodiment the predator protection device 400 may be a mesh net.

In the preferred embodiment that predator protection device 400 is constructed of a substantially rigid wire mesh, such as the type of wire mesh used to construct lobster traps. In the most preferred embodiment the predator protection device 400 is comprised of one or more side walls 410, each having a top edge 412 and a bottom edge 414 and oriented substantially vertically, and a floor 420 oriented substantially horizontally. The floor 420 is attached to the bottom edge 414 of each of the side walls 410, and the top edge 412 of each of the side walls 410 is attached to the flotation device 200. In this configuration the predator protection device 400 fits around the outside of the vertical support members 260 and floor component 270 of the floatation device 200. See FIG. 1. The use of the predator protection device 400 addresses a major problem with prior art spat collection systems, such as rope systems, in that predators 20, such as sea ducks, learn to swim underwater to the ropes to feed on the spat 10 and mollusks attached thereto. The predator protection device 400 interposes a physical barrier between such predators 20 and the spat collection panels 100, thereby increasing the yield of harvestable spat 10.

The system 1 as described above is extremely easy to use. Once placed in an appropriate marine environment in which mollusks are present, the natural currents, tides, and flows will bring free floating wild spat 10 into contact with the spat collection panels 100. The spat 10, by their nature, will adhere to the solid surfaces of the spat collection panels 100, and thereafter will mature and grow. Eventually the spat 10 will reach a harvestable size; at that time, the spat collection panels 100 may be individually removed from the system 1, the spat 10 retrieved, and the spat collection panels 100 replaced to continue the collection process.

One method of collecting spat contemplated by the present invention uses the above described system 1 comprising at least a plurality of spat collection panels 100, a floatation device 200, and a suspension mechanism 300. The spat collection panels 100 utilize a plurality of pegs 130 as described above. The method comprises the steps of: (1) obtaining the above described system 1; (2) deploying the system 1 in a marine environment; (3) allowing the system 1 to remain in the marine environment for an appropriate length of time; (4) withdrawing one or more spat collection panels 100 from the marine environment, and for each such spat collection panel 100: (A) scraping accumulated spat 100 from the spat collection panel 100 into a container 40 using a scraper 30, and then (B) replacing the spat collection panel 100 into the marine environment; and (5) repeating Steps (3) and (4) as necessary. See FIG. 4.

An alternative method comprises the same steps described above but utilizes a system 1 further comprising a predator protection device 400 constructed of a substantially rigid wire mesh and having one or more side walls 410 and a floor 420.

Another alternative method comprises the same steps described above but utilizes a system 1 wherein the plurality of pegs 130 are removably attached to the spat collection panels 100. In this alternative method, two additional steps are performed. The first is removing all pegs 130 associated with each spat collection panel 100 after withdrawing one or more spat collection panels 100 from the marine environment in Step (4) and prior to scraping accumulated spat 100 from the spat collection panel 100, also in Step (4). The second is replacing all pegs 130 associated with each spat collection panel 100 after scraping accumulated spat 100 from the spat collection panel 100 in Step (4) and prior to performing Step (5).

Yet another alternative method comprises the same steps described above but requires the spat collection panels 100 to remain submerged in the marine environment for an extended length of time in Step (3). Using this method, Step (4) comprises scraping mature mollusks rather than spat 10 from the spat collection panel 100 into a container 40 using a scraper 30.

Other variations of the above methods are also contemplated, such as withdrawing all of the spat collection panels 100 at one time before scraping the spat 10 into containers 40, or withdrawing more than one but less than the total number of spat collection panels 100 at one time before scraping the spat 10 into containers 40.

Modifications and variations may be made to the disclosed embodiments of the present invention without departing from the subject or spirit of the present invention as defined in the following claims.

I claim:

1. A system for collecting spat comprising:
a plurality of spat collection panels, each of said plurality of spat collection panels being substantially planar, substantially rigid, and having a first surface and a second surface;
a floatation device suitably adapted to be placed in a marine environment whereby said floatation device floats substantially at the surface of said marine environment, said floatation device suitably adapted to support said plurality of spat collection panels; and
a suspension mechanism suitably adapted to removably attach said plurality of spat collection panels to said floatation device whereby each of said plurality of spat collection panels is suspended below said floatation device in a substantially vertical orientation.

2. The system for collecting spat of claim 1 further comprising
a predator protection device, said predator protection device attached to and positioned below the floatation device such that said predator protection device extends around and below the plurality of spat collection panels, enclosing, in conjunction with the floatation device, the plurality of spat collection panels, said predator protection device being substantially porous such that water, spat, and nutrients may pass through it.

3. The system for collecting spat of claim 2 wherein the predator protection device is constructed of a substantially rigid wire mesh.

4. The system for collecting spat of claim 3 wherein the predator protection device is comprised of
one or more side walls, each said side wall having a top edge and a bottom edge and oriented substantially vertically; and
a floor oriented substantially horizontally;
wherein said floor is attached to the bottom edge of each of the one or more side walls, and the top edge of each of the one or more side walls is attached to the flotation device.

5. The system for collecting spat of claim 1 wherein each of the plurality of spat collection panels comprises a plurality of pegs, with one or more such pegs attached to and depending from the first surface of said spat collection panel in a substantially perpendicular orientation to said spat collection panel, and one or more such pegs attached to and depending from the second surface of said spat collection panel in a substantially perpendicular orientation to said spat collection panel.

6. The system for collecting spat of claim 5 wherein each of the plurality of pegs associated with each of the plurality of spat collection panels is removably attached to said spat collection panel.

7. The system for collecting spat of claim 1 wherein each of the plurality of spat collection panels comprises a plurality of pegs, each said peg having a first end and a second end, with each such peg projecting through said spat collection panel such that the first end of said peg depends from the first surface of said spat collection panel in a substantially perpendicular orientation to said spat collection panel and the second end of said peg depends from the second surface of said spat collection panel in a substantially perpendicular orientation to said spat collection panel.

8. The system for collecting spat of claim 7 wherein each of the plurality of pegs associated with each of the plurality of spat collection panels is removably attached to said spat collection panel.

9. The system for collecting spat of claim 1 wherein each of the plurality of spat collection panels has a textured first surface and a textured second surface.

10. The system for collecting spat of claim 1 wherein the plurality of spat collection panels are constructed of at least one material providing said spat collection panels with neutral buoyancy.

11. The system for collecting spat of claim 1 wherein the floatation device comprises
a substantially open, rigid frame, said frame oriented substantially horizontally;
a plurality of horizontal support members within said frame, one or more said horizontal support members suitably adapted to support the suspension mechanism, with said horizontal support members arranged such that gaps are formed between adjacent horizontal support members and gaps are formed between the frame and adjacent horizontal support members, whereby said gaps are wide enough to permit a spat collection panel to pass through said gaps; and
floatation material.

12. The system for collecting spat of claim 11 wherein the floatation device further comprises a covering mechanism which is suitably adapted to be placed over at least a portion of the plurality of horizontal support members and suitably adapted to be positioned to either provide or deny access to the spat collection panels through the gaps.

13. The system for collecting spat of claim 11 wherein
the floatation device further comprises
a plurality of vertical support members, each said vertical support member having an upper end and a lower end with the upper end attached to the frame, with each said vertical support member depending downward from the frame and oriented substantially vertically, each said vertical support member substantially the same length as each other said vertical support member, and
a floor component attached to the lower ends of the plurality of vertical support members, said floor component oriented substantially horizontally; and
each of the plurality of spat collection panels further comprises
a plurality of engagement feet depending downward therefrom, with said engagement feet suitably adapted to engage with the floor component of the floatation device.

14. The system for collecting spat of claim 13 wherein the suspension mechanism is comprised of a plurality of rods,
each of said rods suitably adapted to pass through a spat collection panel substantially perpendicular to a surface of said spat collection panel and to engage with at least one horizontal support member.

15. The system for collecting spat of claim 1 wherein the suspension mechanism is comprised of a plurality of rods,
each of said rods suitably adapted to pass through a spat collection panel substantially perpendicular to a surface of said spat collection panel and to engage with the floatation device.

16. The system for collecting spat of claim 1 wherein the suspension mechanism is comprised of one or more of the group of: rope, flexible wire cable, and chain.

17. A system for collecting spat comprising:
a plurality of spat collection panels,
each of said plurality of spat collection panels being substantially planar, substantially rigid, and having a textured first surface, a textured second surface, and a plurality of pegs, wherein for each said spat collection panel one or more of said pegs are attached to and depend from the first surface of said spat collection panel in a substantially perpendicular orientation to said spat collection panel, and one or more of said pegs are attached to and depend from the second surface of said spat collection panel in a substantially perpendicular orientation to said spat collection panel, and
each of said plurality of spat collection panels is further comprised of a plurality of engagement feet depending downward therefrom;
a floatation device,
said floatation device suitably adapted to be placed in a marine environment whereby said floatation device floats substantially at the surface of said marine environment,
said floatation device suitably adapted to support said plurality of spat collection panels,
said floatation device comprised of a substantially open, rigid frame, with a plurality of horizontal support members within said frame, said frame oriented substantially horizontally and one or more of said horizontal support members suitably adapted to support said plurality of spat collection panels, with said horizontal support members arranged such that gaps are formed between adjacent horizontal support members and gaps are formed between the frame and adjacent horizontal support members, whereby said gaps are wide enough to permit a spat collection panel to pass through said gaps,
said floatation device further comprised of a plurality of vertical support members, each said vertical support member having an upper end and a lower end with the upper end attached to said frame, with each said vertical support member depending downward from said frame and oriented substantially vertically, each said vertical support member substantially the same length as each other said vertical support member, and a floor component attached to the lower ends of the plurality of vertical support members, said floor component oriented substantially horizontally, and
said floatation device further comprised of a covering mechanism which is suitably adapted to be placed over at least a portion of the plurality of horizontal support members and suitably adapted to be positioned to either provide or deny access to the spat collection panels through said gaps;
a suspension mechanism,
said suspension mechanism suitably adapted to removably attach said plurality of spat collection panels to one or more of said horizontal support members of said floatation device whereby each of said plurality of spat collection panels is suspended below said floatation device in a substantially vertical orientation; and
a predator protection device,
said predator protection device attached to and positioned below the floatation device such that said predator protection device extends around and below the plurality of spat collection panels, enclosing, in conjunction with the floatation device, the plurality of spat collection panels, said predator protection device constructed of a substantially rigid wire mesh, and
said predator protection device comprised of one or more side walls, each said side wall having a top edge and a bottom edge and oriented substantially vertically, and a floor oriented substantially horizontally, wherein said floor is attached to the bottom edge of each of the one or more side walls, and the top edge of each of the one or more side walls is attached to the flotation device;
wherein each of said engagement feet of said spat collection panels is suitably adapted to engage with the floor component of the floatation device.

18. A method for collecting spat comprising the steps of:
(1) procuring a spat collection system comprising
a plurality of spat collection panels, each of said plurality of spat collection panels being substantially planar, substantially rigid, and having a first surface, a second surface, and a plurality of pegs, wherein for each said spat collection panel one or more of said pegs are attached to and depend from the first surface of said spat collection panel in a substantially perpendicular orientation to said spat collection panel, and one or more of said pegs are attached to and depend from the second surface of said spat collection panel in a substantially perpendicular orientation to said spat collection panel;
a floatation device suitably adapted to be placed in a marine environment whereby said floatation device floats substantially at the surface of said marine environment, said floatation device suitably adapted to support said plurality of spat collection panels, said floatation device comprised of a substantially open, rigid frame, with a plurality of support members within said frame, said frame oriented substantially horizontally and one or more of said support members suitably adapted to support said plurality of spat collection panels, with said support members arranged such that gaps are formed between adjacent support members and gaps are formed between the frame and adjacent support members, whereby said gaps are wide enough to permit a spat collection panel to pass through said gaps; and
a suspension mechanism suitably adapted to removably attach said plurality of spat collection panels to one or more of said horizontal support members of said floatation device whereby each of said plurality of spat collection panels is suspended below said floatation device in a substantially vertical orientation;
(2) deploying said spat collection system in a marine environment;
(3) allowing said spat collection system to remain in said marine environment for an appropriate length of time;
(4) withdrawing one or more spat collection panels from said marine environment, and for each such spat collection panel scraping accumulated spat from said spat collection panel into a container; and
(5) performing the following substeps zero or more times:
(A) replacing the one or more spat collection panels into said marine environment, and
(B) repeating Steps (3) and (4).

19. The method for collecting spat of claim 18, wherein said spat collection system further comprises
a predator protection device, said predator protection device attached to and positioned below the floatation device such that said predator protection device extends around and below the plurality of spat collection panels, enclosing, in conjunction with the floatation device, the plurality of spat collection panels, said predator protection device constructed of a substantially rigid wire mesh, said predator protection device comprised of one or more side walls, each said side wall having a top edge and a bottom edge and oriented substantially vertically, and a floor oriented substantially horizontally, wherein said floor is attached to the bottom edge of each of the one or more side walls, and the top edge of each of the one or more side walls is attached to the flotation device.

20. The method for collecting spat of claim 18, wherein
each of the plurality of pegs associated with each of the plurality of spat collection panels is removably attached to said spat collection panel; and
said method for collecting spat further comprising the steps of:
for each spat collection panel withdrawn from said marine environment in Step (4), removing all pegs associated with said spat collection panel before scraping accumulated spat from said spat collection panel into a container; and
for each spat collection panel withdrawn from said marine environment in Step (4), replacing all pegs associated with said spat collection panel after scraping accumulated spat from said spat collection panel into a container and before performing Step (5).
